(19) United States
(12) Patent Application Publication
(10) Pub. No.: US 2011/0073327 A1
(43) Pub. Date: Mar. 31, 2011

(54) Two-component mortar composition and method of using same

(75) Inventor: Thomas Buergel, Landsberg am Lech (DE)

(73) Assignee: Hilti Aktiengesellschaft

(21) Appl. No.: 12/924,555

(22) Filed: Sep. 28, 2010

(30) Foreign Application Priority Data
Sep. 30, 2009 (DE) 10 2009 043 792.4

(51) Int. Cl. E21B 23/00; C09K 8/46

(52) U.S. Cl. 166/382; 523/130

(57) ABSTRACT

A two-component mortar composition contains a curable resin component (A), and a curing agent component (B), which is separated therefrom to inhibit reaction and contains, in the resin component (A), a reactive diluent mixture, which comprises at least one hydroxyalkyl di(meth)acrylate, at least one alkyl (meth)acrylate and at least one acetoacetato compound of the general formula (I). A method of fastening an anchoring element in boreholes in mineral substrates includes filling a borehole with the inventive two-component mortar composition, inserting an anchoring element in the borehole immediately after filling the borehole with the mortar composition; with the anchoring element being set after a predetermined time period necessary for the chemical reaction of the resin component (A) with a curing agent components (B).

### BACKGROUND OF THE INVENTION

1. Field of the Invention

The subject matter of the present invention relates to a two-component mortar composition with a resin component (A) which can be cured by a redox initiator system and contains 5 to 30% by weight of at least one free radical polymerizable resin, 3 to 45% by weight of a reactive diluent mixture, 30 to 75% by weight of fillers and 1 to 8% by weight of a thickening agent, and a curing agent component (B) which is disposed separately therefrom to inhibit reaction and contains 1 to 20% by weight of a peroxide as a component of a redox initiator system, 1 to 25% by weight of polymer particles of 99.9 to 70% by weight of a polymer or mixture of polymers produced by aqueous emulsion polymerization, 0.1 to 30% by weight of an accelerator as a second component of the redox initiator system and which is predominantly bound covalently in the polymer particles or is present encapsulated in the polymer particles, 10 to 35% by weight of water, 40 to 80% by weight of fillers and 0.5 to 5% by weight of thickening agents, on condition that the total amount of the constituents of the resin component or of the curing agent component in each case amounts to 100% by weight, and the use of this two-component mortar composition for securing anchoring means in boreholes in mineral substrates by chemical reaction.

2. Description of the Prior Art

Chemical mortar compositions and dowel compositions based on the free radical curing reaction resins have long been known. These reaction resins usually are composed of a curable resin component and a curing agent component. The resin component comprises, for example, a free radical polymerizable resin, an accelerator as part of the redox initiators system, as well as fillers and conventional additives, such as a thickening agent. The curing agent component, which is disposed separately from the resin component so as to inhibit reaction, comprises, for example, peroxide as a second part of the redox initiator system, as well as also fillers and conventional additives, such as thickening agents, dyes, pigments and the like.

When such a two-component mortar composition is used, the resin component is mixed with the curing agent component and introduced into the borehole in a mineral substrate such as concrete, after which the anchoring means is introduced into the borehole filled with the mortar composition and adjusted. Subsequently, the mortar composition cures. Various such chemical mortar compositions are known from the prior art.

For example, the DE 32 26 602 A1 describes a curable two-component mortar composition, which contains an unsaturated polyester resin, a reactive diluent, fillers, thixotropic agents and a free radical curing catalyst.

The subject matter of DE 36 17 702 A1 is a curable agent for fastening dowels and anchor rods with a content of curable acrylate, which, aside from an organic peroxide curing agent, contains an accelerator, a phlegmatizing agent, mineral fillers, thixotropic agents and a reactive diluent.

The DE 39 40 309 A1 also describes a mortar composition for fastening anchoring means in solid accommodating materials, with a content of free radical curable vinyl ester urethane resins and a reactive diluent as component of choice.

The DE 42 31 161 A1 also discloses a two-component mortar composition for fastening anchoring means in borehole with a content of hydraulically binding and/or polycondensable compounds as inorganic, curable compounds, and curable vinyl esters as organic, curable compounds.

The DE 195 31 648 A1 discloses a dowel composition for chemically fastening anchor rods, threaded sleeves and screws in boreholes, which contains a reaction resins and, spatially separated therefrom, a curing agent for the resin. Since the object of this prior art is to make available an initiator, which, when packed in an airtight manner, ensures a sufficiently long shelf life even in the presence of light, the essential feature of this dowel composition is the presence of a piperidinyl-N-oxyl or of a tetrahydropyrrole-N-oxyl as inhibitor. The reaction resin comprises at least 20% by weight of a vinyl ester resin or a vinyl ester urethane resin and may contain a methacrylic ester as comonomer.

Finally, in the DE 41 31 457 A1, a two-component mortar composition for chemically fastening anchor rods, dowels and screws in boreholes is described. It contains a free radical curable vinyl ester resin or vinyl urethane resin and, spatially separated therefrom, a curing agent for the resin, as well as an acetacetoxy alkyl (meth)acrylate as comonomer, for achieving good adhesion to silicate materials.

The DE 10 2004 035 567 B4 discloses a two-component mortar composition, which contain a reactive diluent mixture, which consists of at least one hydroxy alkyl (meth)acrylate and at least one acetacetoxy alkyl (meth)acrylate in a particular ratio by weight, in the curable resin component. With this reactive diluent, the adhesion of the mortar composition to concrete substrates as well as to brick substrates, is clearly better than that of two-component mortar compositions, which have been optimized for use in concrete or for use in brick substrates by the selection of the reactive diluent.

The DE 103 39 329 A1 describes monomer-polymer systems with a controllable pot life. For using the two-component mortar compositions under consideration, it is of interest to vary the pot life, that is, the time available for processing after the resin component is mixed with the curing agent component of the two-component mortar composition, and to adapt this time to the existing working process. According to the teachings of this prior art, it is possible to adjust this pot life within wide limits by disposing one component of the redox initiator system on the particles of a polymer, produced by aqueous emulsion polymerization or absorbing it on such polymer particles.

The DE 10 2007 032 836 A1 discloses a further embodiment of these technical teachings, according to which these polymer particles consist of an emulsion polymer, which contains a particular activator, which is incorporated in the emulsion polymer by covalent bonds. This activator is a (meth)acryloyl-functionalized amine derivative, such as N—((meth)acryloyl(poly)oxyalkyl)-N-alkyl-(o,m,p)-(mono,di-,tri-,tetra-,penta-) alkylaniline, N-(meth)-acryloyl(poly)-oxyalkyl)-N-(arylalkyl)-(o-,m-,p-)-(mono-,di-,tri-,tetra-,penta-) alkylaniline, N-((meth)acryloyl)poly)-oxyalkyl)-N-alkyl-(o-,m-,p-)-(mono-,di-,tri-,tetra-,penta- etc.) alkylnaphtylamine, N-((meth)acrylamidoalkyl)-N-alkyl-(o-,m-,p-)-(mono,di-,tri-,tetra-,penta-) alkylaniline. Examples of further amines are N,N dimethylaminoethyl (meth)acrylate, diethylamino-ethyl (meth)acrylate, 3-dimethylamino-2,2-dimethylpropyl (meth)acrylate, t-butylaminoethyl (meth)acrylate, N-vinylimidazol and dimethylaminopropyl (meth)acrylamide. N-((meth)acryloyloxyethyl)-N-methylaniline, N-((meth)acryloyl-oxypropyl)-N-methylaniline, N-((meth)acryloyl-oxypropyl)-N-methyl-(o-,m-,p-)-toluidine, N-((meth)acryloyloxyethyl)-N-methyl-(o-,m-,p-)-toluidine, N-((meth)acryloyl-polyoxyethyl)-N-methyl-(o-,m-,p-)-toluidine are preferred. It is possible to use these substances individually or in mixtures of two or more. With the help of these polymer-fixed activators or accelerators, it becomes possible to form two-component mortar compositions with long gel times.

Here and below, the expression (meth)acrylate means that in these compounds, methacrylates as well as acrylates, such as, e.g., methyl methacrylate or methyl acrylate can be used.

The aqueous dispersion of the accelerator, bound to the polymer particles, is added to the also aqueous curing agent component. When this curing agent component is mixed with the resin component, the reactive diluents of the accelerator polymer, contained in the resin component, swells so that the accelerator is released and the cross linking of the mortar sets in. When this technology was investigated in real injection mortar, it turned out that gel times of at least 24 hours at 0° C. and failure loads are attained, which are only 50% of the levels customary at the present time. At the same time, curing at low temperatures was possible only to a very limited extent.

Admittedly, the gel time can be adjusted by varying the concentration of a hydroxyalkyl methacrylate, such as hydroxyethyl methacrylate or hydroxypropyl methacrylate. However, values noticeably below 30 minutes are not reached and the low temperature curing remains unsatisfactory.

The use of very polar monomers, such as acetoacetatoethyl methacrylate or the use of particularly readily soluble reactive diluents, such as methyl methacrylate or tetrahydrofurfuryl methacrylate, did not lead to a shortening of the gel time.

An object of the present invention consists in providing a two-component mortar composition of the type described above, which has a variable pot life, which is below the range which is possible according to the prior art discussed, and which mortar compositions cure even at low temperatures, for example, at 0° C., without loss of failure load.

A further object of the present invention consists in providing a method of fastening an anchoring element in a borehole in a mineral substrate with the inventive two-component mortar composition.

### SUMMARY OF THE INVENTION

The inventor has found that, with a reactive diluent mixture, which comprises a combination of three particular monomers, it becomes possible to achieve gel times in a range from 10 to 15 minutes at 25° C. and, at the same time, to use the mixture even at 0° C., with failure loads being reached, which match those required for the intended application.

Accordingly, the objects of the invention have been achieved by providing a two-component mortar composition with a resin component (A) which can be cured by a redox initiator system and contains 5 to 30% by weight of at least one free radical-polymerizable resin, 3 to 45% by weight of a reactive diluent mixture, 30 to 75% by weight of fillers and 1 to 8% by weight of a thickening agent, and a curing agent component (B) which is disposed separately therefrom to inhibit reaction and contains 1 to 20% by weight of a peroxide as a component of a redox initiator system, 1 to 25% by weight of polymer particles of 99.9 to 70% by weight of a polymer or mixture of polymers produced by aqueous emulsion polymerization, 0.1 to 30% by weight of an accelerator as a second component of the redox initiators system, and which is predominantly bound covalently in the polymer particles or is present encapsulated in the polymer particles, 10 to 35% by weight of water, 40 to 80% by weight of fillers and 0.5 to 5% by weight of thickening agents, on condition that the total amount of the constituents of the resin component or the curing agent component, respectively, in each case amounts to 100% by weight, characterized in that the reactive diluent mixture contains at least one hydroxyalkyl (meth)acrylate, at least one alkyl (meth)acrylate and at least one acetoacetato compound of the general formula (I):

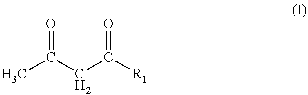

in which R₁ represents hydrogen, a C₁-C₆ alkyl group or an —OR₂ group, wherein R₂ is a C₁-C₆ alkyl group, a group of formula (II):

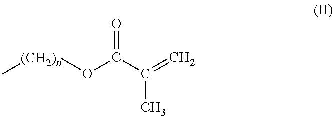

or a group of formula (III):

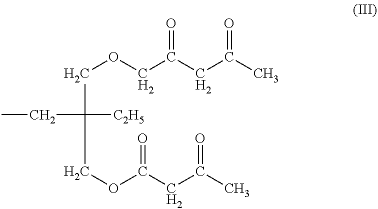

and n is a whole number with a value of 1 to 6 inclusive.

According to a preferred embodiment, the reactive diluent mixture of the resin component (A) contains, as hydroxyalkyl (meth)acrylate, hydroxyethyl methacrylate, hydroxypropyl methacrylate and/or hydroxybutyl methacrylate, as alkyl (meth)acrylate, methyl methacrylate and/or ethyl methacrylate and, as acetoacetato compound of the general formula (I), acetyl acetone, acetoacetatoethyl methacrylate and/or triacetoacetatotrimethylol propane.

Preferably, as free-radical polymerizable resin, the resin component (A) comprises at least one representative of the group comprising unsaturated polyester resins, vinyl ester resins, such as epoxy acrylate, epoxy acrylates preferably synthesized by the addition of (meth)acrylic acid to epoxide resins and ethoxylated bisphenol (meth)acrylate as disclosed in the EP 0 534 201, and vinyl ester urethane resins. As vinyl ester urethane resins, urethane methacrylate resins and/or urethane dimethacrylate resins are preferred, while as unsaturated polyester resins, especially unsaturated polyester resins, which are based on o-phthalic acid or iso-phthalic acid, maleic acid or fumaric acid as dicarboxylic acid and on low molecular weight aliphatic polyols, preferably diols, are preferred.

According to a further embodiment of the invention, the resin component (A) additionally contains 0 to 30% by weight of an additional reactive diluent which contains one or two acrylate groups, such as tetrahydrofurfuryl methacrylate, isobornyl methacrylate, butanediol dimethacrylate, ethylene glycol dimethacrylate, hexanediol dimethacrylate, polyethylene glycol methacrylate, polyethylene glycol dimethacrylate, diethylene glycol dimethacrylate and/or triethylene glycol dimethacrylate.

According to a further embodiment of the invention, the resin component (A) contains 0 to 1% by weight of a polymerization inhibitor, such as a phenolic or free radical polymerization inhibitor, preferably 4-hydroxy-3,5-di-t-butyl toluene, butyl catechol, hydroquinone and/or 2,2,6,6-tetramethylpiperidinyl-1-oxide or derivatives thereof.

The curing agent component (B) preferably contains, as accelerator, a tertiary aromatic amine, a toluidine or a xylidine and/or a cobalt, manganese tin or cerium salt. The curing agent component (B) may contain as accelerator, N,N-dimethylaniline, N,N-diethylaniline, N,N-dimethyl-p-toluidine, N,N-bis(hydroxy-ethyl)-p-toluidine, N,N-bis(hydroxypropyl)-p-toluidine, N,N-bis(hydroxyethyl)-m-toluidine, N-bis(2-hydroxyethyl)-xylidine, cobalt octoate and/or cobalt naphthenate encapsulated in polymer particles.

In a particularly advantageous manner, the curing agent component (B) contains, as polymer particles, particles of an emulsion polymer, which may be obtained according to the method described in DE 10 2007 032 836 A1 by the aqueous emulsion polymerization of a mixture having:
a. 5 to 99.9% by weight of a monomer or a plurality of monomers with a water solubility <2% by weight at 20° C., selected from the group comprising monofunctional (meth)acrylate monomers, styrene, and vinyl esters;
b. 0 to 70% by weight of a monomer or a plurality of monomers copolymerizable with the monomers a):
c. 0 to 20% by weight of a compound or a plurality of compounds vinylically unsaturated two or more times,
d. 0 to 20% by weight of a polar monomer or a plurality or polar monomers with a water solubility of >2% by weight at 20° C., and
e. 0.1 to 95% by weight of at least one accelerator, which is incorporated in the emulsion polymer by means of covalent bonds and corresponds to Formula IV

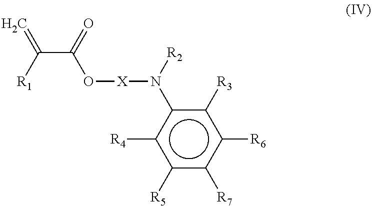

wherein
R₁ is hydrogen or methyl,
X is a linear or branched alkane diyl group with 1 to 18 carbon atoms, which may be substituted one or more times with hydroxyl groups and/or with C₁-C₄ alkoxy groups,
R₂ is hydrogen or a linear or branched alkyl group with 1 to 12 carbon atoms, which may optionally be substituted one or more times by hydroxyl groups or C₁-C₄ alkoxy groups, wherein the hydroxyl groups may be partially esterified with (meth)acrylic acid, and
R₃, R₄, R₅, R₆ and R₇ independently of one another, represent hydrogen or a linear or branched alkyl or alkoxy group with 1 to 8 carbon atoms, which may be substituted one or more times with hydroxy groups, and wherein, if necessary, two of the R₃ to R₇ groups are combined with one another to form a five-membered to seven-membered ring and, if necessary, form a condensed aromatic ring system with the phenyl group, the components a) to e) constituting 100% by weight of the polymerizable constituents of the mixture.

For the inventive two-component mortar composition, the resin component (A) as well as the curing agent component (B) or also both components may contain quartz, powdered quartz, pyrogenic silica, cement, glass, silicates, aluminosilicates, aluminum oxide, corundum, porcelain, stone ware, barium sulfate, gypsum, talcum and/or chalk as filler.

As thickening agent, the resin component (A) as well as the curing agent component (B) or also both components may contain phyllosilicates, such as bentonite or smectite, pyrogenic silica and/or organic substances, such as amide waxes, urea derivatives or castor oil derivatives.

As peroxide, the curing agent component (B) preferably contains dibenzoyl peroxide. methyl ethyl ketone peroxide, t-butyl perbenzoate, cyclohexanone peroxide, lauroyl peroxide, cumene hydroperoxide and/or t-butyl peroxy-2-ethyl hexanoate.

The method of fastening an anchoring element, e.g., an anchor rod, in mineral substrates, such as concrete, brick, natural stone or the like by the chemical reaction of the resin component (A) with the curing agent component (B) includes the steps of:

providing a two-component mortar composition with a resin component (A), which can be cured by a redox initiator system and contains to 30% by weight of at least one free radical-polymerizable resin, 3 to 45% by weight of a reactive diluent mixture, 30 to 75% by weight of fillers and 1 to 8% by weight of a thickening agent and a curing agent component (B), which is disposed separately therefrom to inhibit reaction and contains 1 to 20% by weight of a peroxide as a component of a redox initiator system, 1 to 25% by weight of polymer particles of 99.9 to 70% by weight of a polymer or mixture of polymers produced by aqueous emulsion polymerization, 0.1 to 30% by weight of an accelerator as a second component of the redox initiators system, which is predominantly bound covalently in the polymer particles or present encapsulated in the polymer particles, 10 to 35% by weight of water, 40 to 80% by weight of fillers and 0.5 to 5% by weight of thickening agents, on condition that the total amount of the constituents of the resin component or the curing agent component, respectively, in each case amounts to 100% by weight, characterized in that the reactive diluent mixture contains at least one hydroxyalkyl (meth)acrylate, at least one alkyl (meth)acrylate and at least one acetoacetato compound of the general formula (I):

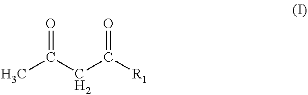

in which R₁ represents hydrogen, a C₁-C₆ alkyl group or an —OR₂ group, wherein R₂ is a C₁-C₆ alkyl group, a group of formula (II):

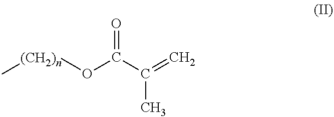

or a group of formula (III):

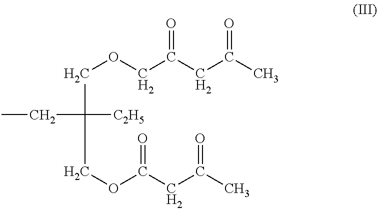

and n is a whole number with a value of 1 to 6 inclusive;
drilling a borehole in a mineral substrate;
cleaning the borehole;
filling the borehole with the mortar composition; and
immediately thereafter, inserting the anchoring element in the borehole;
wherein the anchoring element is fixedly set in the borehole after expiration of a predetermined time period necessary for curing the mortar composition.

### BRIEF DESCRIPTION OF THE PREFERRED EMBODIMENTS

The preferred embodiments of the invention will now be described with reference to the following comparison examples and examples intended to explain the invention further.

### Comparison Examples 1 and 2 and Examples 1 to 3

To begin with, the resin components (A) of the comparison examples 1 and 2 as well as of the Examples 1 to 3 of the invention are prepared by mixing the constituents given in the following Table 1:

TABLE I

| | Com- | Com- | | | |
|---|---|---|---|---|---|
| Resin | parison | parison | Example | Example | Example |
| component | 1 (% by | 2 (% by | 1 (% by | 2 (% by | 3 (% by |
| (A) | weight) | weight) | weight) | weight) | weight) |
| Sartomer SR | 24 | 24 | 24 | | |
| 348L* | | | | | |
| Urethane | | | | 15 | 15 |
| methacrylate | | | | | |
| resin | | | | | |
| 1,2-Hydroxy | 6.495 | 8.995 | 3.995 | 7.995 | 12.995 |
| hexane | | | | | |
| dimethacrylate | | | | | |
| Hydroxyethyl | 12.5 | 12.5 | 12.5 | | |
| methacrylate | | | | | |
| Hydroxypropyl | | | | 10 | 5 |
| methacrylate | | | | | |
| Methyl | 5 | | 5 | 4 | 4 |
| methacrylate | | | | | |
| Acetoacetato- | | 2.5 | 2.5 | | |
| ethyl | | | | | |
| methacrylate | | | | | |
| Triacetoacetato | | | | 3 | 3 |
| trimethylol | | | | | |
| propane | | | | | |
| Butylhydroxy- | 0.005 | 0.005 | 0.005 | 0.005 | 0.005 |
| toluene | | | | | |
| Silica | 3 | 3 | 3 | 2 | 2 |
| Corundum | | | | 35 | 35 |
| Powdered | 29 | 29 | 29 | | |
| Quartz | | | | | |
| Kaolin | | | | 5 | 5 |
| Cement | 20 | 20 | 20 | 18 | 18 |
| Total | 100 | 100 | 100 | 100 | 100 |

Sartomer SR 348L = ethoxylated (2) bisphenol A dimethacrylate

Separately, the curing agent component (B) of the comparison examples 1 and 2 as well as of examples 1 to 3 is prepared from the constituents given in Table II.

TABLE II

| | Com- | | | | |
|---|---|---|---|---|---|
| Resin | parison | Comparison | Example | Example | Example |
| component | 1 (% by | 2 (% by | 1 (% by | 2 (% by | 3 (% by |
| (B) | weight) | weight) | weight) | weight) | weight) |
| 40% | 15 | 15 | 15 | 20 | 20 |
| Benzoyl | | | | | |
| peroxide in | | | | | |
| H₂0 | | | | | |
| Polymer | 18.5 | 18.5 | 18.5 | 18.5 | 18.5 |
| dispersion* | | | | | |
| 50% | | | | | |
| Polymer in | | | | | |
| H₂0 | | | | | |
| Powdered | 63.5 | 63.5 | 63.5 | 40 | 40 |
| Quartz | | | | | |
| Aluminum | | | | 20 | 20 |
| oxide | | | | | |
| Silica | 3 | 3 | 3 | | |
| Bentonite | | | | 1.5 | 1.5 |
| Total | 100 | 100 | 100 | 100 | 100 |

*according to DE 10 2007 032 836 A1

The polymer dispersion consists of the polymer particles of an emulsion polymer, which may be obtained by the aqueous emulsion polymerization, which is described above and in greater detail in the DE 10 2007 032 836 A1.

For investigating the properties of these two-component mortar compositions, the resin component (A) is mixed with the curing agent component (B) of the comparison examples 1 and 2 and of the examples 1 to 3 in a ratio by volume of 3:1. The mixture is introduced into boreholes in concrete and threaded M12 rods, 72 mm long, are introduced into the boreholes and allowed to cure at 25° C. and at 0° C. The gel time is measured in the manner described below and the failure load is measured as follows.

### Determining the Gel Time

The two-component mortar composition, consisting of the resin component (A) and the curing agent component (B), are mixed with the help of a static mixer, filled into a test tube and clamped in a device, which moves a stamp in the mortar composition, as long as the consistency of the mortar composition makes this possible. The solidification of the mortar composition is determined and corresponds to the end of the processing time. The time up to the solidification is determined and referred to as the gel time.

### Measuring the Failure Load

For determining the failure load, a borehole is produced by means of a hammer drill in a mineral substrate, concrete in this case. The borehole is blown out with an air blast and cleaned with a suitable steel brush, and the two-component mortar composition, consisting of the resin component (A) and the curing agent component (B), after passing through a static mixer, is introduced into the borehole having a diameter of 14 mm and a depth of 72 mm. An M12 anchor rod of suitable steel strength is set immediately into the composition, which has not yet cured. After a sufficient time has elapsed, which varies between 2 and 24 hours, depending on the reactivity, the mortar composition has cured and the anchor rod is pulled out of the concrete by a central tension with measurement of the pull-out force.

The results, obtained from these investigations, are summarized in the following table:

TABLE III

| Mixture | | | | | |
|---|---|---|---|---|---|
| (A)/(B) 3:1 | Com- | Com- | | | |
| (Vol./Vol.) | parison 1 | parison 2 | Example 1 | Example 2 | Example 3 |
| Gel time | 17:10 min | 16:00 min | 12:00 min | 10:30 min | 18:50 min |
| at 25° C. | | | | | |
| Gel time | No curing | 28 h | 5:30 h | 3:40 min | 12 h |
| at 0° C. | | | | | |
| Failure | — | 26.9 | 56.8 | 67.6 | 53.0 |
| load in | | | | | |
| setting | | | | | |
| trial at | | | | | |
| 10° C. | | | | | |

As is evident from the above Table, short gel times are obtained at 25° and 0° C. only with the inventive mortar compositions of Examples 1 to 3 without a decrease in failure load. As can be seen from the comparison Examples 1 and 2, when one of the three essential components of reactive diluent mixture is missing, an adequately short gel time, particularly at low temperatures, is not attained and the mortar composition either does not cure at all or results in the having of the failure load.

This behavior of the two-component mortar composition, when a reactive diluent mixture, which contains at least one hydroxyalkyl (meth)acrylate, at least one alkyl (meth)acrylate and at least one acetoacetato compound of the general formula given, is used in accordance with the invention, could not have been anticipated in any way.

Though the present invention was shown and described with references to the preferred embodiments, such are merely illustrative of the present invention and not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A two-component mortar composition, comprising a resin component (A) which can be cured by a redox initiator system and contains 5 to 30% by weight of at least one free radical-polymerizable resin, 3 to 45% by weight of a reactive diluent mixture, 30 to 75% by weight of fillers, and 1 to 8% by weight of a thickening agent; and a curing agent component (B) which is disposed separately therefrom to inhibit reaction and contains 1 to 20% by weight of a peroxide as a component of a redox initiator system, 1 to 25% by weight of polymer particles of 99.9 to 70% by weight of a polymer or mixture of polymers produced by aqueous emulsion polymerization, 0.1 to 30% by weight of an accelerator as a second component of the redox initiators system and which is predominantly bound covalently in the polymer particles or is present encapsulated in the polymer particles, 10 to 35% by weight of water, 40 to 80% by weight of fillers, and 0.5 to 5% by weight of thickening agents, on condition that the total amount of the constituents of the resin component or the curing agent component, respectively, in each case amounts to 100% by weight, characterized in that the reactive diluent mixture contains at least one hydroxyalkyl (meth)acrylate, at least one alkyl (meth)acrylate and at least one acetoacetato compound of the general formula (I): 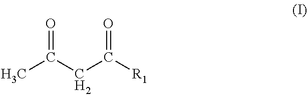
in which R₁ represents hydrogen, a C₁-C₆ alkyl group or an —OR₂ group, wherein R₂ is a C₁-C₆ alkyl group, a group of formula (II): 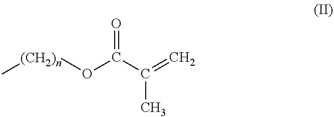
or a group of formula (III): 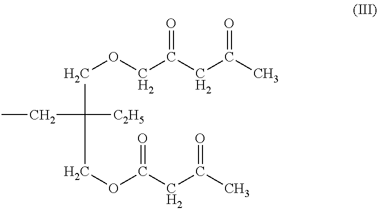
and n is a whole number with a value of 1 to 6 inclusive;

2. A two-component mortar composition of claim 1, characterized in that the reactive diluent mixture comprises hydroxyethylmethacrylate, hydroxypropyl methacrylate and/or hydroxybutyl methacrylate as hydroxyalkyl (meth)acrylate, and methylmethacrylate and/or ethylmethacrylate as alkyl(meth)acrylate, and acetyl acetone, acetoacetatoethyl methacrylate and/or triacetoacetatotrimethylol propane as acetoacetato compound of the general formula (I).

3. The two-component mortar composition of claim 1, characterized in that the resin component (A), as a free radical polymerizable resin, contains at least one representative of the group consisting of unsaturated polyester resins, vinyl ester resins and vinyl ester urethane resins.

4. The two-component mortar composition of claim 3, characterized in that the resin component (A), as a vinyl ester urethane resin, contains a urethane methacrylate resin and/or a urethane dimethacrylate resin and/or, as an unsaturated polyester resin, contains an unsaturated polyester resin based on o- and/or iso-phthalic acid, maleic acid or fumaric acid as dicarboxylic acid and low molecular weight aliphatic polyols, preferably diols.

5. The two-component mortar composition of claim 1, characterized in that the resin component (A) additionally contains 0 to 30% by weight of an additional reactive diluent, additionally having one or two acrylate groups.

6. The two-component mortar composition of claim 5, characterized in that the resin component (A), as an additional reactive diluent, contains tetrahydrofurfuryl methacrylate, isobornyl methacrylate, butanediol dimethacrylate, ethylene glycol dimethacrylate, hexanediol dimethacrylate, polyethylene glycol methacrylate, polyethylene glycol dimethacrylate, diethylene glycol dimethacrylate and/or triethylene glycol dimethacrylate.

7. The two-component mortar composition of claim 1, characterized in that the resin component (A) contains 0 to 1% by weight of a polymerization inhibitor.

8. The two-component mortar composition of claim 7, characterized in that the resin component (A), as polymerization inhibitor, contains a phenolic or free radical polymerization inhibitor, preferably 4-hydroxy-3,5-di-t-butyl toluene, butyl catechol, hydroquinone and/or 2,2,6,6-tetramethylpiperidinyl-1-oxide or the derivatives thereof.

9. The two-component mortar composition of claim 1, characterized in that the curing agent component (B) contains a tertiary aromatic amine, a toluidine or xylidine and/or a cobalt, manganese, cerium salt as accelerator.

10. The two-component mortar composition of claim 10, characterized in that the curing agent component (B) contains as accelerator, encapsuled in the polymer particles, N,N-dimethylaniline, N,N-diethylaniline, N,N-dimethyl-p-toluidine, N,N-bis(hydroxy-ethyl)-p-toluidine, N,N-bis(hydroxypropyl)-p-toluidine, N,N-bis(hydroxyethyl)-m-toluidine, N-bis(2-hydroxyethyl)-xylidine, cobalt octoate and/or cobalt naphthenate encapsulated in the polymer particles.

11. The two-component mortar composition of claim 1, characterized in that the curing agent component (B), as polymer particles, contains particles of an emulsion polymer, which can be obtained by the aqueous emulsion polymerization of a mixture, having
a. 5 to 99.9% by weight of a monomer or a plurality of monomers with a water solubility <2% by weight at 20° C., selected from the group comprising monofunctional (meth)acrylate monomers, styrene and vinyl esters;
b. 0 to 70% by weight of a monomer or a plurality of monomers copolymerizable with the monomer a):
c. 0 to 20% by weight of a compound or a plurality of compounds vinylically unsaturated two or more times,
d. 0 to 20% by weight of a polar monomer or a plurality of polar monomers with a water solubility >2% by weight at 20° C., and
e. 0.1 to 95% by weight of at least one accelerator, which is incorporated in the emulsion polymer by means of covalent bonds and corresponds to Formula IV 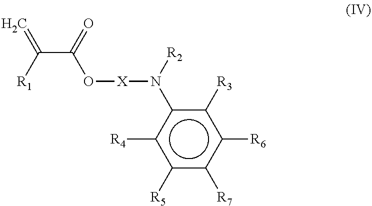
wherein
R₁ is hydrogen or methyl,
X is a linear or branched alkane diyl group with 1 to 18 carbon atoms, which may be substituted one or more times with hydroxyl groups and/or with C₁-C₄ alkoxy groups,
R₂ is hydrogen or a linear or branched alkyl group with 1 to 12 carbon atoms, which may optionally be substituted one or more times by hydroxyl groups of C₁-C₄ alkoxy groups, wherein the hydroxyl groups may be partially esterified with (meth)acrylic acid, and
R₃, R₄, R₅, R₆ and R₇ independently of one another represent hydrogen or a linear or branched alkyl or alkoxy group with 1 to 8 carbon atoms, which may be substituted one or more times with hydroxy groups and wherein optionally two of the R₃ to R₇ groups are combined with one another and optionally form a five-membered to seven-membered ring and optionally a condensed aromatic ring system with the phenyl group, the components a) to e) constituting 100% by weight of the polymerizable constituents of the mixture.

12. The two-component mortar composition of claim 1, characterized in that the resin components (A) and/or the curing agent components (B) contain quartz, pyrogenic silica, cement, glass, silicates, aluminosilicates, aluminum oxide, corundum, porcelain, stone ware, barium sulfate, gypsum, talcum and/or chalk as filler.

13. The two-component mortar composition of claim 1, characterized in that the resin component (A) and/or the curing agent component (B) contain phyllosilicates, such as bentonite or smectite, pyrogenic silica and/or organic substances, such as amide waxes, urea derivatives, castor oil derivatives as thickening agents.

14. The two-component mortar composition of claim 1, characterized in that the curing agent component (B), as peroxide, contains dibenzoyl peroxide, methyl ethyl ketone peroxide, t-butyl perbenzoate, cyclohexanone peroxide, lauroyl peroxide, cumene hydroperoxide and/or t-butyl peroxy-2-ethyl hexanoate.

15. A method of fastening an anchoring element in a borehole in mineral substrates by chemical reaction of the resin component (A) with the curing agent component (B), comprising the steps of:
providing a two-component mortar composition the steps of providing a two-component mortar composition with a resin component (A) which can be cured by a redox initiator system and contains 5 to 30% by weight of at least one free radical-polymerizable resin, 3 to 45% by weight of a reactive diluent mixture, 30 to 75% by weight of fillers and 1 to 8% by weight of a thickening agent, and a curing agent component (B) which is disposed separately therefrom to inhibit reaction and contains 1 to 20% by weight of a peroxide as a component of a redox initiator system, 1 to 25% by weight of polymer particles of 99.9 to 70% by weight of a polymer or mixture of polymers produced by aqueous emulsion polymerization, 0.1 to 30% by weight of an accelerator as a second component of the redox initiators system and which is predominantly bound covalently in the polymer particles or is present encapsulated in the polymer particles, 10 to 35% by weight of water, 40 to 80% by weight of fillers, and 0.5 to 5% by weight of thickening agents, on condition that the total amount of the constituents of the resin component or the curing agent component, respectively, in each case amounts to 100% by weight, characterized in that the reactive diluent mixture contains at least one hydroxyalkyl (meth)acrylate, at least one alkyl (meth)acrylate and at least one acetoacetato compound of the general formula (I): 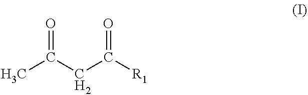
in which R₁ represents hydrogen, a C₁-C₆ alkyl group or an —OR₂ group,
wherein R₂ is a C₁-C₆ alkyl group, a group of formula (II): 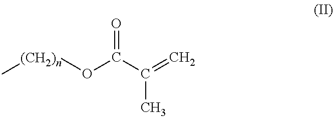
or a group of formula (III): 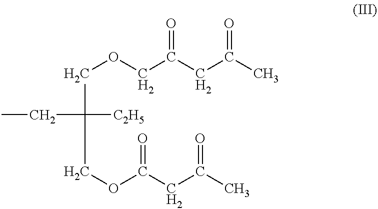
and n is a whole number with a value of 1 to 6 inclusive;
drilling a borehole in a mineral substrate;
cleaning the borehole;
filling the borehole with the mortar composition; and
immediately thereafter, inserting the anchoring element in the borehole;
wherein the anchoring element is fixedly set in the borehole after expiration of a predetermined time period necessary for curing the mortar composition.
